(19) United States
(12) Patent Application Publication
(10) Pub. No.: US 2010/0031189 A1
(43) Pub. Date: Feb. 4, 2010

(54) Connecting Standard Operating System Windows with a Visual Tack

(75) Inventor: Frank Groezinger, Dornhan (DE)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/184,806

(22) Filed: Aug. 1, 2008

(51) Int. Cl. G06F 3/048

(52) U.S. Cl. 715/804

(57) ABSTRACT

The method presented herein is directed to connecting and coordinating the movements of two or more windows open on a display screen. The method provides for the application of a visual tack indicator to show the user that the windows are grouped together and to distribute commands to each window in the group.

### BACKGROUND OF THE INVENTION

1. Field of the Invention

The present invention is related generally to connecting and coordinating the movements of two or more windows open on a display screen. More specifically, the present invention provides for the application of a visual tack indicator to show the user that the windows are grouped together.

2. Description of Background

A personal computer user opens during his daily work many applications in different windows. After a while there are more windows visible than the screen can display without overlapping windows. For some editing jobs, the user arranges the windows to be able to read the content of one window and edit in the other window. These two open windows can be considered as a logical group. During the use of the two open windows, it may happen that the user has to open further windows, e.g., additional applications, or activate a background window. Additionally, there are instances where windows pop up automatically.

To return to the original state, i.e., the first two open windows are in front, it is necessary to execute many clicks in the right sequence to restore the screen to the two open window configuration and to continue the editing job. Referring to FIG. 1, current desktop organization helper tools solve this problem by connecting the window borders 5. The bigger window 10 becomes the master and the smaller window 15 becomes the slave. To create the connection the smaller windows must be moved to the border of the larger window. The connection is established if the borders of the frames are placed side by side. The connected windows can be assumed as a logical group. The logical group of windows allow following actions: movement of both windows simultaneously, e.g., by dragging the larger window to another place on the screen the whole logical group is moved and activation. e.g., if the logical group is partly hidden by another window the click into the area of the larger window will activate both windows and bring them into the front position.

To disconnect the windows the user has to move the smaller window in any direction. The connection is disconnected if the borders are no longer in direct contact.

The prior art solution has numerous disadvantages. For example, it is impossible to connect windows having equal size. Further, the move and activation actions for the group can only be executed on the master window, i.e., the larger window. Moves and activations of the slave are only valid for the slave itself. The connected windows cannot overlap themselves. They can only be grouped side by side. Additionally, if the master window is resized in a way that it is getting smaller than the slave window, the logical group is disconnected. And there is no visual representation available for the status that the 2 windows are connected. Finally, the number of windows for a logical group is limited to 4 windows, because only one slave window can be connected on each side of the master window.

### SUMMARY OF THE INVENTION

In an embodiment of the present invention, a computer program product for displaying an electronic tack when executed on at least one computer is described. The computer program product causes the at least one computer to: implement user instructions to open at least two separate user windows on a display; implement user instructions to overlap the at least two separate windows; implement user instructions to position an electronic tack icon at a user selected position on an overlapping portion of the at least two separate windows: implement each of the following commands simultaneously for all windows at the pixel position and under the electronic tack when selected for a single window under the electronic tack: move window, bring window to front of non-tacked windows, close window. The computer program product implements user instructions to position an electronic tack icon at a user selected position on an overlapping portion of the at least two separate windows by: obtaining a pixel position for the user selected position; determining which of the at least two separate windows are located at the pixel position and storing the result of this determination in a manager application; associating a command application with each of the at least two separate windows, wherein the command application determines when a command has been applied to one of the at least two separate windows located at the pixel position and distributes that command to all windows located at the pixel position; and causing an electronic tack icon to be displayed at the user selected position.

### Technical Effects

The method presented herein is directed to a computer program product for connecting and coordinating the movements of two or more windows open on a display screen. The method provides for the application of a visual tack indicator to show the user that the windows are grouped together and to distribute commands to each window in the group.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 presents a prior art architecture for connecting multiple interface windows;

FIGS. 2a and 2b illustrates an architecture for connecting multiple windows in accordance with one exemplary embodiment of the present invention;

FIG. 3 illustrates a process for placing an electronic tack in accordance with one exemplary embodiment of the present invention;

FIG. 4 illustrates a process for moving windows within a logical group attached with an electronic tack in accordance with one exemplary embodiment of the present invention; and

FIG. 5 illustrates a process for removing an electronic tack and disconnecting a logical group in accordance with one exemplary embodiment of the present invention.

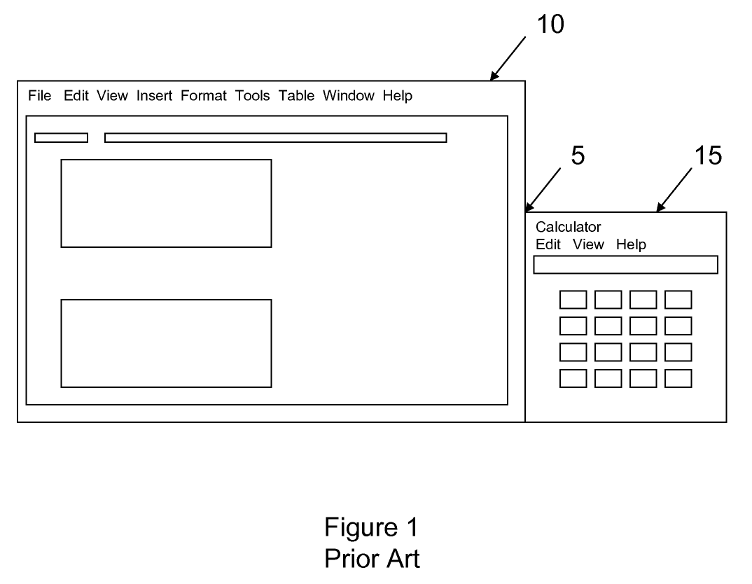

### DETAILED DESCRIPTION OF THE INVENTION

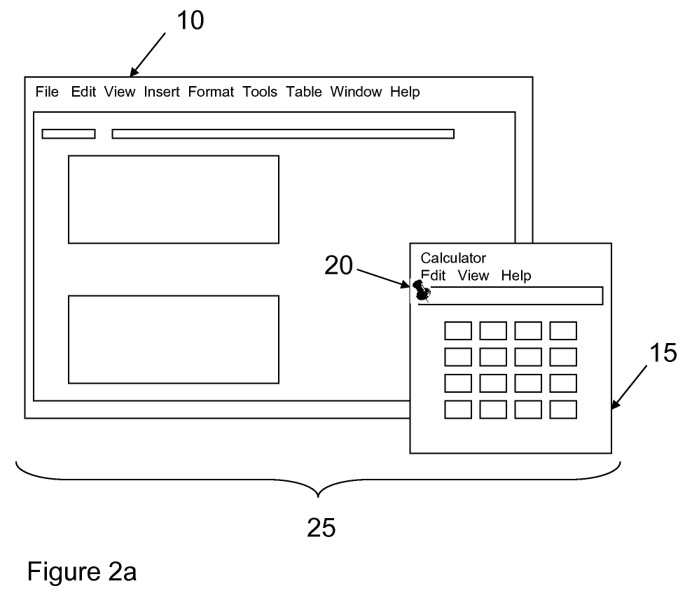

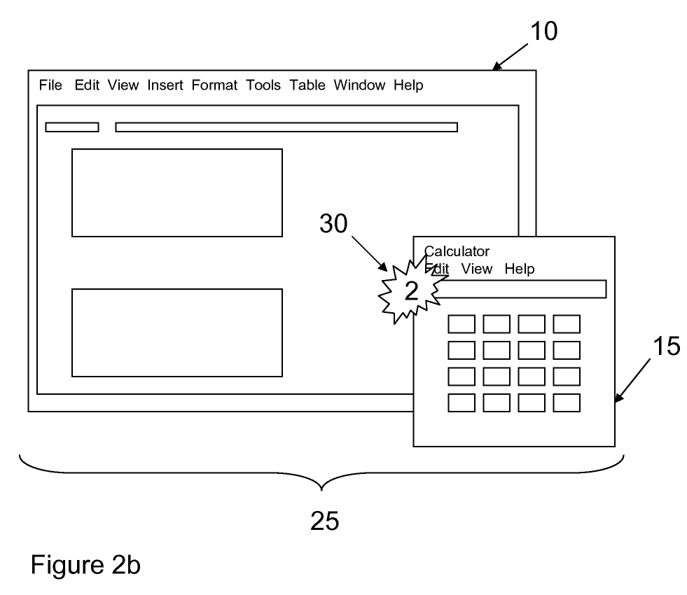

According to an embodiment of the present invention, FIGS. 2a and 2b illustrate the positioning of a visual representation, e.g., electronic tack 20, for creating, representing and deleting the logical group 25. By using the electronic tack 20 to create logical window groups such as group 25 it is possible to connect windows of varying sizes, overlapping windows and an unlimited number of windows. Further, move and activation actions for the group can be executed on any window of the logical group without disconnecting the logical group. Additionally, the visual representation, i.e., the electronic tack 20, is able to show the number of windows that are members of the logical group 25. For example, moving the cursor over the electronic tack 20 in FIG. 2b would reveal to the user the number “2” in the space where the electronic tack is located 30.

More specifically, the electronic tack 20 works in general like a physical tack on a pin board. It is possible to stick it at any pixel on the screen. All windows that are located behind this pixel in Z-order (3 dimensional ) are logically grouped. Clicking on the head of the electronic tack with the cursor pressing causes the z-order of the windows switch, if there are just 2 windows in the logical group or to scroll through all windows under the electronic tack. Windows that are connected by an electronic tack are moved together during move actions, are activated and set to front together on click on any one of the individual windows. Multiple windows can be closed, minimized, maximized, restored together as well. Essentially, many window actions can be transferred to all other windows within the logical group through the electronic tack.

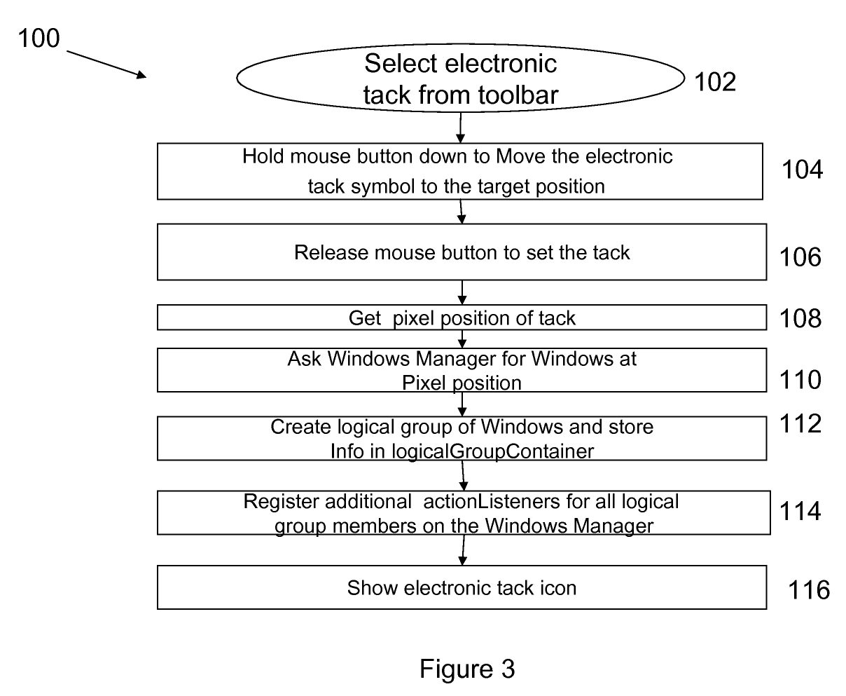

In a process 100 shown in FIG. 3 for establishing an electronic tack, the tack is selected by a user from a toolbar that is available in one ore more of the open windows 102. The user holds down the left mouse button and moves the electronic tack to a target position 104. The target position is a position where at least 2 windows that the user wishes to group are overlapping. By releasing the left mouse button, the electronic tack is set in place 106. The computer program obtains the pixel position where the tack was placed 108; asks the windows manager which windows are located at that pixel position 110; creates a logical group of windows and stores this information in a logical group container 112; registers additional action listeners on the windows manager for all windows comprising the logical group 114; and shows the electronic tack at the target position 116. At this point, the user can open as many other windows as they choose, place them on top of the logical group and the 2 windows will remain connected. Further, clicking on either of the 2 connected windows will bring the entire logical group to the front. The z-order of the 2 connected windows will be the same as the order was when the electronic tack was originally stuck. Said another way, the logical group acts like one single window, e.g., if you open a further window then it will appear in front of the logical group. And, if you click to one of the grouped windows then all windows of the logical group come to the front and the z-order of the logical group remain like tacked.

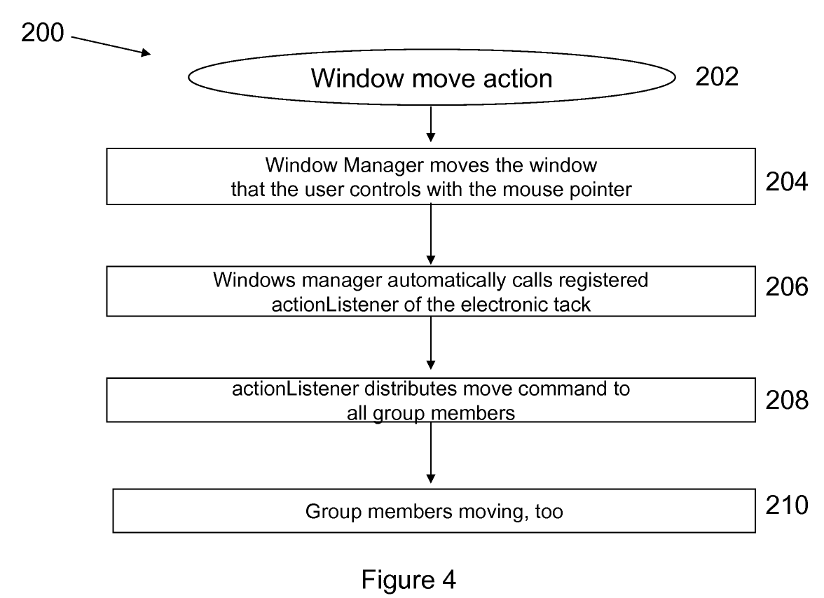

Referring to process 200 illustrated in FIG. 4, when a user initiates a window move action 202, the window manager moves the window that the user controls with the mouse pointer 204. The windows manager automatically calls the registered action listener associated with the electronic tack 206 and the action listener distributes the move command to all windows in the logical group 208. All members of the logical group move with the selected window 210, i.e., by moving one window of the logical group all windows will be moved.

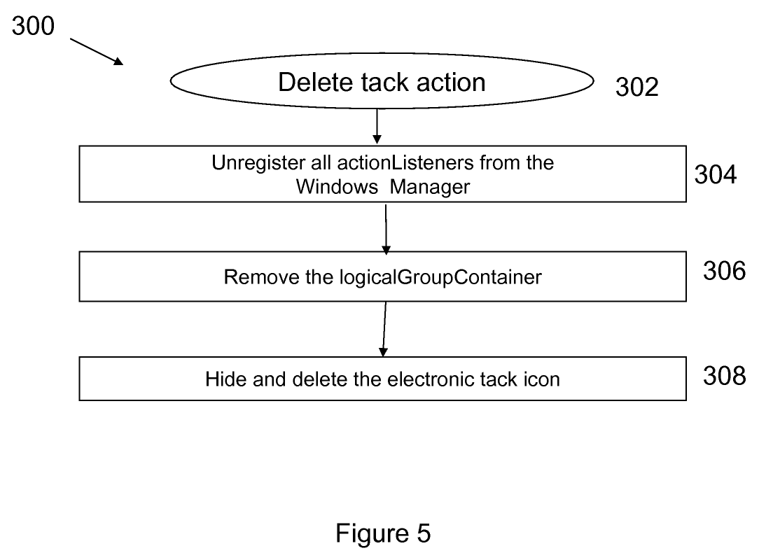

Referring to process 300 illustrated in FIG. 5, when a user initiates a delete electronic tack action 302, the process first unregisters action listeners from the windows manager for that particular tack 304. Next, the logical group container is removed 306. Finally, the electronic tack icon is hidden and deleted 308.

The electronic tack can be implemented for all operating systems that offer a graphical user interface ( e.g. Microsoft Windows®, Linux, AIX®, etc.). More specifically, operating systems with a graphical user interface provide a windows manager programming Interface that allows the development of graphical applications. The “electronic tack” will be implemented as a windows manager application using windows manager API.

In addition to the functions described herein, the computer implemented application can also maintain a list of existing tacks, e.g., the process contemplates multiple logical groups, each connected by a separate electronic tack. Each list entry contains the information “involved windows” and for each involved window the relative coordinates where the tack is placed in that window. The application also provides additional options and variants of the tack, such as different life times, e.g., survive login session y/n; allow more than one tack for a single window, e.g., transitive tacking; or issue an error message when the user tries to place a second tack to a window.

1. A computer program product for displaying an electronic tack comprising a computer readable program, wherein the computer readable program when executed on at least one computer causes the at least one computer to:
implement user instructions to open at least two separate user windows on a display;
implement user instructions to overlap the at least two separate windows;
implement user instructions to position an electronic tack icon at a user selected position on an overlapping portion of the at least two separate windows by:
obtaining a pixel position for the user selected position;
determining which of the at least two separate windows are located at the pixel position and storing the result of this determination in a manager application;
associating a command application with each of the at least two separate windows, wherein the command application determines when a command has been applied to one of the at least two separate windows located at the pixel position and distributes that command to all windows located at the pixel position; and
causing an electronic tack icon to be displayed at the user selected position;
implement each of the following commands simultaneously for all windows at the pixel position and under the electronic tack when selected for a single window under the electronic tack: move window, bring window to front of non-tacked windows, close window,
wherein the electronic tack icon displays the number of windows located at the pixel position and under the electronic tack.
